(19) United States
(12) Patent Application Publication
(10) Pub. No.: US 2005/0264486 A1
(43) Pub. Date: Dec. 1, 2005

(54) Plasma display panel and driving method thereof

(76) Inventors: Seung-Hun Chae, Suwon-si (KR); Woo-Joon Chung, Suwon-si (KR); Jin-Sung Kim, Suwon-si (KR); Jin-Ho Yang, Suwon-si (JP)

Correspondence Address: Robert E. Bushnell, Suite 300, 1522 K Street, N.W., Washington, DC, 20005-1202, US

(21) Appl. No.: 11/134,384

(22) Filed: May 23, 2005

(30) Foreign Application Priority Data
May 25, 2004 (KR) 10-2004-0037294

(51) Int. Cl. G09G 3/28

(52) U.S. Cl. 345/63

(57) ABSTRACT

A plasma display panel and a driving method thereof The driving method includes estimating a gray scale of an input image signal and checking on/off patterns of discharge cells in a sub-field representing the gray scale, identifying an insufficient discharge cell having the insufficient discharging pattern among the on/off patterns of the discharge cells, and increasing the width of a scan pulse applied to first electrodes of the insufficient discharge cell during an address period of the sub-field in which the identified insufficient discharge cell is discharged. With this method, efficiency of an address-discharge can be enhanced.

### CLAIM OF PRIORITY

This application makes reference to, incorporates the same herein, and claims all benefits accruing under 35 U.S.C. §119 from an application for PLASMA DISPLAY PANEL AND DRIVING METHOD THEREOF earlier filed in the Korean Intellectual Property Office on 25 May 2004 and there duly assigned Serial No. 10-2004-0037294.

### BACKGROUND OF THE INVENTION

1. Field of the Invention

The present invention relates to a plasma display panel (PDP) and a driving method of the PDP, and more particularly, to a PDP and a driving method of the PDP that enhances the efficiency of a sustain discharge.

2. Discussion of the Related Art

Recently, flat panel displays, such as liquid crystal displays (LCDs), field emission displays (FEDs), and PDPs, have been actively developed. PDPs are advantageous over other flat panel displays due to their high luminance, high luminous efficiency, and wide viewing angle. Accordingly, the PDPs are being highlighted as a substitute for conventional cathode ray tubes (CRTs) for displays larger than 40 inches.

The PDPs use plasma generated by gas discharge to display characters or images. PDPs can include more than several tens of thousands to millions of pixels arranged in a matrix. PDPs are classified into a direct current (DC) type and an alternating current (AC) type according to patterns of waveforms of driving voltages and discharge cell structures.

The DC PDP has electrodes directly exposed to a discharge space, thus causing current to flow through the discharge space during application of a voltage. DC PDPs require a resistor for limiting the current. On the other hand, the electrodes in an AC PDPs are covered with a dielectric layer that naturally forms a capacitance to limit the current while protecting the electrodes from the impact of ions during a discharge. As a result, the AC PDP has a longer lifespan than the DC PDP.

In AC PDPs, a unit frame in time is made up of a series of sub-fields. Each sub-field is II made up of a reset period followed by an address period where the pixel is selected followed by the sustain period where the main image is produced. Gray scales for each pixel are determined by discharging various combinations of sub-fields within a frame, each sub-field representing a different weight in a frame. A problem occurs when a pixel is not selected for one or more sub-fields in a row and then needs to be selected during a present sub-field by an address discharge. Because the pixel has not recently been selected, there are fewer priming particles present than if it had been recently selected. This lack of priming particles can prevent the pixel from properly discharging. Therefore, what is needed is a method and an apparatus for overcoming this mis-discharging during the address period when the previous one or more sub-fields did not contain an address discharge or a sustain discharge.

### SUMMARY OF THE INVENTION

It is therefore an object of the present invention to provide a method for overcoming the mis-discharging problem in a sub-field when the previous one or more sub-fields for that particular pixel were not selected.

It is also an object of the present invention to provide an apparatus for overcoming the mis-discharging of a cell that has not been recently selected.

These and other objects may be achieved by a method and an apparatus that lengthens the time width of a scan pulse applied to an electrode during the address period of a sub-field for a pixel that has not been recently selected. The time allocated to lengthen the width of the scan pulse is borrowed from a pausing period located between different unit frames.

More specifically, the present invention pertains to a PDP that includes a panel that in turn includes a plurality of first and second electrodes, a controller estimating a gray scale of an input image signal, checking an on/off pattern of discharge cells in a sub-field based on the estimated gray scale, and adjusting the width of a scan pulse based on the on/off pattern, and a driver alternately is applying a scan pulse to the plurality of first electrodes based on a signal output from the controller.

The controller detects an insufficient discharge cell by determining whether the discharge cell has been selected for discharge in the previous two sub-fields, the (n-1)th and (n-2)th sub-fields in sequence and whether the discharge cell is to be discharged in the present nth sub-field, and increases the width of the scan pulse applied to at least first electrodes of the insufficient discharge cell during the address period of the present sub-field.

The controller includes a pattern detector that checks a gray scale of the input image signal, checks an on/off pattern of the discharge cell in the sub-field corresponding to the gray scales by consulting a memory, and identifies the insufficient discharge cell, and a data converter increases the width of the scan pulse applied to the first electrodes during an address period of the present sub-field from which the insufficient discharge cell is generated by consulting an auto power control module and then outputting the scan pulse when the insufficient discharge cell is identified by the pattern detector.

The data converter increases the width of the scan pulse by not more than the width of a pausing period of the frame that includes the present sub-field. The data converter reduces the pausing period by an amount equal to an amount that the width of the scan pulse is increased to compensate for the increased width of the scan pulse. The data converter increases the width of scan pulses applied to the first electrodes during the address period of the present sub-field from which the insufficient discharge cell is generated.

In another aspect of the present invention, a driving method of a PDP having a plurality of first electrodes and a plurality of second electrodes, includes estimating a gray scale of an input image signal and checking on/off patterns of discharge cells in a sub-field representing the gray scale, identifying an insufficient discharge cell having the insufficient discharging pattern among the on/off patterns of the discharge cells, increasing the width of a scan pulse applied to first electrodes of the insufficient discharge cell during an address period of the sub-field in which the identified insufficient discharge cell is discharged.

The insufficient discharge cell is a discharge cell discharged in a present nth sub-field but not discharged in the previous two sub-fields, i.e., the (n-1)th and the (n-2) sub-fields. The insufficient discharge cell can instead be a cell that is presently being discharged in the second sub-field and was not discharged in the first sub-field of a frame.

The increasing the width of a scan pulse increases the width of scan pulses applied to first electrodes of the sub-field from which the insufficient discharge cell is generated. The increasing the width of a scan pulse reduces a pausing period of a frame that includes the sub-field by an amount equal to an amount that the scan pulse width has been increased.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating a part of a general AC PDP;

FIG. 2 illustrates an arrangement of electrodes of a PDP of FIG. 1;

FIG. 3 illustrates a method of expressing gray scales of an AC PDP;

FIG. 4 illustrates an example of sub-field data representing gray scales;

FIG. 5 illustrates a driving waveform of a PDP;

FIG. 6 illustrates a PDP according to an embodiment of the present invention; and

FIG. 7 is a diagram illustrating an internal configuration of a controller of the PDP of FIG. 6 according to the embodiment of the present invention.

### DETAILED DESCRIPTION OF THE INVENTION

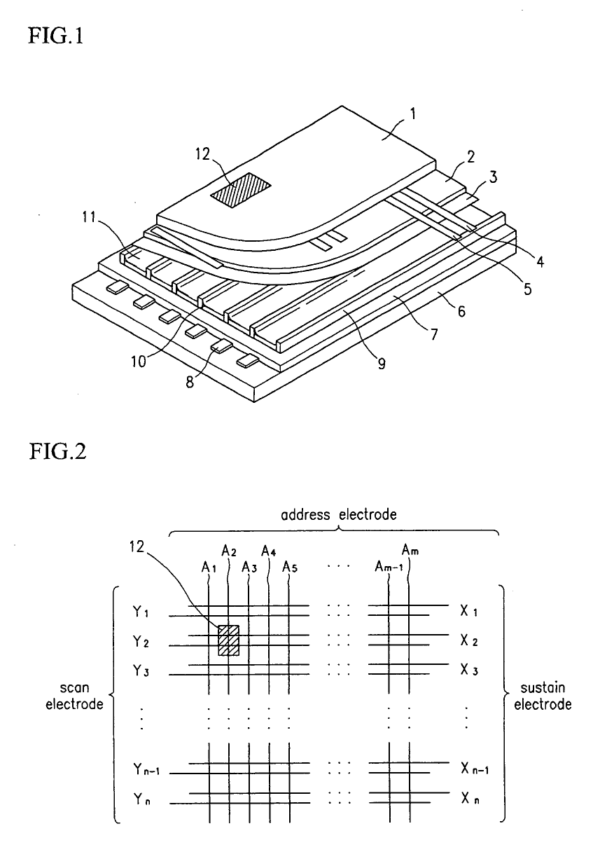

Turning now to the figures, FIG. 1 is a perspective view illustrating a part of an AC PDP. As illustrated in FIG. 1, scan electrodes 4 and sustain electrodes 5, covered with a dielectric layer 2 and a protective layer 3, are arranged in pairs in parallel on a first glass substrate 1. A plurality of address electrodes 8, covered with an insulation layer 7, are arranged on a second glass substrate 6. Partition walls 9 are formed in parallel with the address electrodes 8 on the insulation layer 7 such that each partition wall 9 is located between two adjacent address electrodes 8. A phosphor 10 is coated on the surface of the insulation layer 7 and on both sides of each partition wall 9.

The first and second glass substrates 1 and 6 are sealed together and define a discharge space 11 therebetween, such that the address electrodes 8 are orthogonal to the scan electrodes 4 and 11 orthogonal to the sustain electrodes 5. An intersection between each address electrode 8 and each pair of the scan and sustain electrodes 4 and 5 forms a discharge cell 12 in the discharge space 11.

Turning now to FIG. 2, FIG. 2 illustrates an arrangement of electrodes in the PDP of FIG. 1. As illustrated in FIG. 2, the electrodes of the PDP have an n x m matrix format. Specifically, address electrodes (A₁ to Aₘ) are arranged in columns, and scan electrodes (Y₁ to Yₙ) and sustain electrodes (X₁ to Xₙ) are arranged in rows. From now on, a scan electrode (or first electrode) is referred to as a “Y electrode,” and a sustain electrode (or a second electrode) is referred to as an “X electrode.” A discharge cell 12 illustrated in FIG. 2 corresponds to the discharge cell 12 illustrated in FIG. 1.

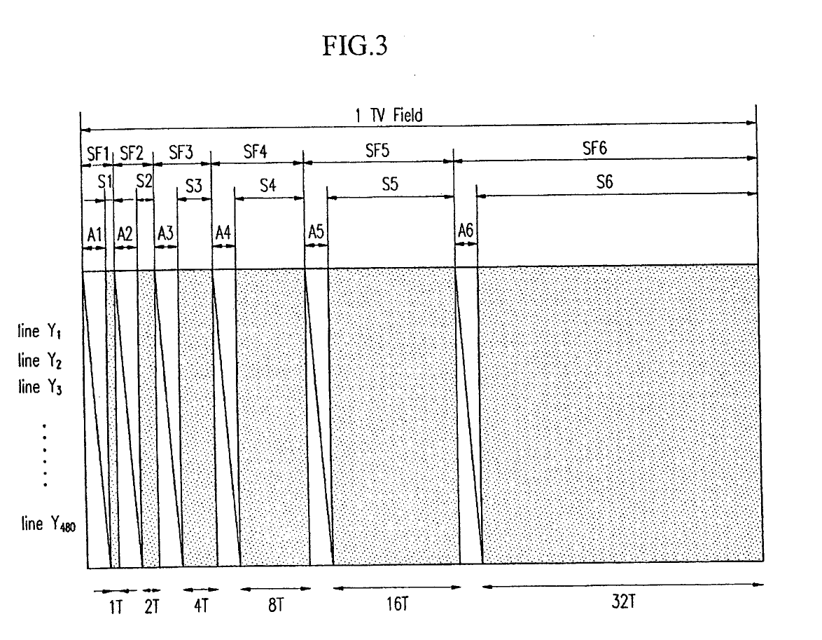

Turning now to FIG. 3, FIG. 3 is a driving waveform diagram of a PDP. When the PDP is driven by frames, a single frame is divided into a plurality of sub-fields, each sub-field representing a different weight, and a combination of these sub-fields expresses gray scales. FIG. 3 illustrates a method of expressing a gray scale of an AC PDP. Each sub-field includes an address period A and a sustain period S.

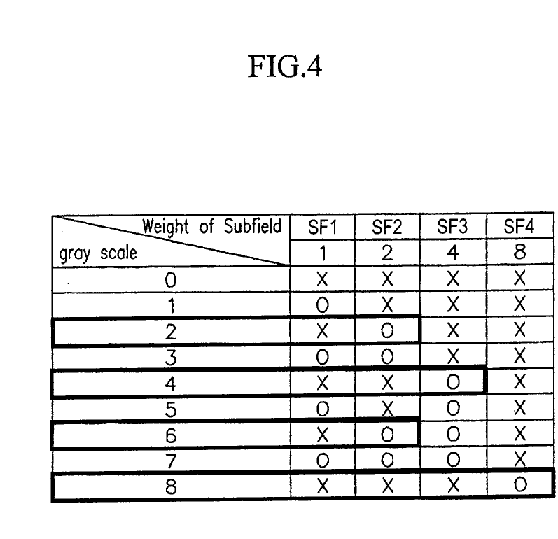

According to a such a driving diagram, when expressing various gray scales for a discharge cell, an initial discharge can occur in a sub-field for a discharge cell that has no occurrence of a discharge in the two previous sub-fields. Also, the first discharge can occur in the second sub-field instead when no discharge occurred in the first sub-field of a frame. This can be seen by consulting the table in FIG. 4. FIG. 4 illustrates a gray scale representation of weights zero through 8 using a frame with four sub-fields. As illustrated by the bold lines in FIG. 4, each of gray scales 2, 4, 6 and 8 require a discharge in a sub-field where there was no discharge in the previous sub-field. In these 1I instances, an address-discharge time lag can be relatively long due to lack of priming particles. Because the width of each scan pulse for each discharge of FIG. 4 is the same, there is the possibility that the occurrence of the address discharge and the following sustain discharge may not properly form when no address discharge recently occurred.

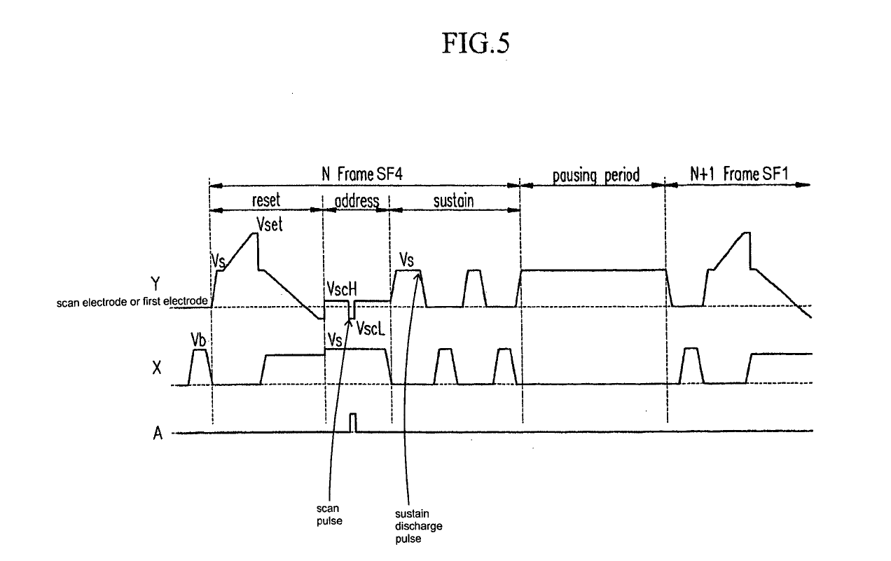

Turning now to FIG. 5, FIG. 5 illustrates a PDP driving waveform where a single frame is made of four sub-fields. As illustrated in FIG. 5, each of the sub-fields into which one frame is divided includes a reset period, an address period, and a sustain period. In the reset period, wall charges formed by a pervious sustain-discharge are erased, and each cell is set up to stably perform the next addressing. In the addressing period, cells are selectively turned on and turned off and the wall charges are accumulated on the turned-on cells (i.e., addressed cell or selected cell). In the sustain period, a sustain-discharge occurs in discharge cells selected during the address period by alternately applying a sustain discharge pulse Vₛ to the X electrodes and the Y electrodes.

Wall charges refer to charges that accumulate near the electrodes and are formed in close proximity to the respective electrodes on the wall (e.g., dielectric layer) of the discharge cells. The wall charges do not actually touch the electrodes themselves, even though they are described as being “formed on,” “stored on,” and/or “accumulated to” the electrodes. Further, a wall voltage represents a potential difference formed on a wall of the discharge cells by the wall charges. An insufficient discharge means that discharge occurs insufficiently, and an insufficiently discharged cell means that the discharge cell generated an insufficient discharge.

When realizing a frame-based moving picture, a period of each frame in a signal input from an image source is changed depending on a type of an image, and thus a frame having the shortest period becomes a reference frame when designing a driving waveform. Any leftover remaining fraction of a shortest period in a frame is consolidated into an inert pausing period between frames as illustrated in FIG. 5.

Typically, a PDP consumes a lot of power because of its driving aspects. Therefore, power consumption must be controlled based on a load of a frame to be displayed. Auto power control (APC) is one technique used to control the power consumption. According to this technique, the sustain-discharge is adjusted to occur less than usual when displaying a bright screen, and the occurrence of the sustain-discharge is increased when displaying a dark screen. Accordingly, the pausing period between a frame displaying the bright screen and a frame displaying the dark screen becomes longer. This pausing period can provide for flexibility in designing new driving techniques as will now be seen.

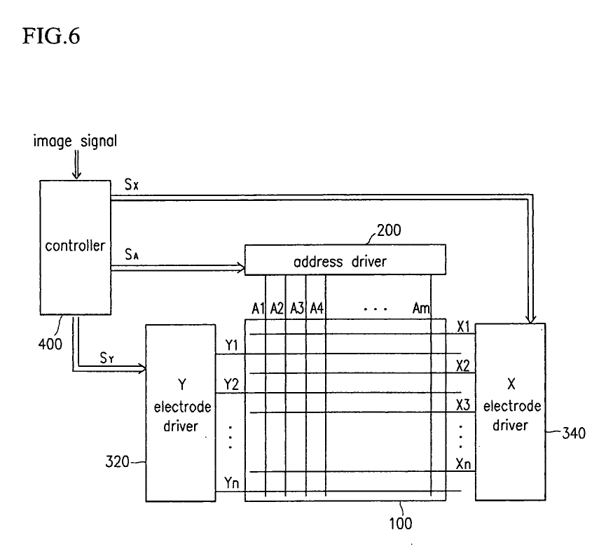

Turning now to FIG. 6, FIG. 6 illustrates a PDP according to an embodiment of the present invention. As illustrated in FIG. 6, the PDP according to the embodiment of the present invention includes a PDP 100, an address driver 200, a Y electrode driver 320, an X electrode driver 340, and a controller 400. The PDP 100 includes address electrodes Al to Am arranged in columns, and first electrodes Y1 to Yn (referred to as “Y electrodes” hereinafter) and second electrodes X1 to Xn (referred to as “X electrodes” hereinafter) arranged in rows.

The address driver 200 receives an address driving control signal SA from the controller 400 and transmits a displaying data signal to each of address electrodes (Al to Am) so as to select a desired discharge cell. The Y electrode driver 320 and the X electrode driver 340 respectively receive a Y electrode driving signal Sy and an X electrode driving signal Sx from the controller 400, and respectively apply the Y electrode driving signal and the X electrode driving signal to the Y electrodes and the X electrodes.

The controller 400 receives an external image signal and generates the address driving signal S_{A}, a Y electrode driving signal S_{Y}, and an X electrode driving signal S_{X}, and transmits these signals (S_{A}, S_{Y}, and S_{X}) to the address driver 200, the Y electrode driver 320, and the X electrode driver 340, respectively.

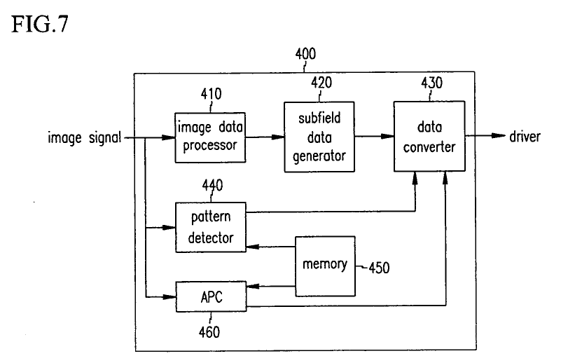

Turning now to FIG. 7, FIG. 7 illustrates an internal configuration of the controller 400 according to the embodiment of the present invention. As illustrated in FIG. 7, the controller 400 according to the present invention includes an image data processor 410, a sub-field data generator 420, a data converter 430, a pattern detector 440, a memory 450, and an auto power controller (APC) 460.

The image data processor 410 compensates an image signal and outputs the compensated image signal, and the sub-field data generator 420 converts the compensated image signal of each frame into data so as to drive a panel with sub-fields. The memory 450 stores an on/off pattern of sub-fields representing each gray scale. The pattern detector 440 detects the gray scale of the image signal of each frame, checks the patterns of the detected gray scale stored in the memory 450, and outputs a checking result. Specifically, the pattern detector 440 determines whether there is a high possibility that the pattern of a sub-field representing a corresponding gray scale is insufficiently discharged during an address period of the sub-field. In other words, the pattern detector 440 determines whether a discharge may not have occurred in the two proceeding sub-field for a discharge cell that is about to discharge. In addition, if the present sub-field is the second sub-field in a frame, the pattern detector determines whether the sub-field was discharged in the first sub-field of the frame. If either of these two patterns exists, the present sub-field for the discharge cell is identified as having an insufficient discharge pattern and its driving signals are processed differently than other sub-field discharge cell combinations.

The APC 460 of controller 400 of FIG. 7 estimates a load rate of an input image signal, and determines maximum and minimum limits of the number of sustain discharge pulses with reference to an auto power control lookup table (APC LUT) stored in the memory 450. The data converter 430 of controller 400 of FIG. 7 converts an output signal of the sub-field data generator 420 on the basis of signals output from the APC 460 and the pattern detector 440, and outputs the converted signal to the respective drivers illustrated in FIG. 6.

An operation of the PDP with the foregoing configuration will now be described in detail with reference to FIG. 7. An external image signal is input to the image data processor 410. The image data processor 410 detects a gray scale of the image signal, and checks the pattern of the gray scale from the memory 450. When the pattern of the gray scale is identified as an insufficient discharge pattern, a signal is transmitted to the data converter 430 to increase the width of a scan pulse generated during an address period of the present sub-field. The data converter 430 converts a data signal of the sub-field based on the signal transmitted from the pattern detector 440, and outputs the converted signal to the respective drivers of FIG. 6.

In the above process, the address period is extended by an amount equal to the increased width of the scan pulse, but this increased width can not be longer than the pausing period. In addition to increasing the width of the scan pulse, the data converter 430 also reduces the pausing period by the same extended amount to compensate for the increased width of the scan pulse. Therefore, a total driving time for a single frame is not changed by these signal modifications.

In addition to these changes brought about by the data converter 430 from the pattern detector 440, the APC 460 also determines whether to further modify the length of the pausing period, To do this, APC 460 estimates a load rate of an input image signal, and determines maximum and minimum limits of the number of the sustain discharge pulses according to the estimated load rate with reference to the APC LUT. The length of the pausing period is determined by the number of sustain discharge pulses. Accordingly, the data converter 430 increases the width of the scan pulse and reduces the pausing period based in part on the determination of the pausing period referring to a signal output from the APC 460. By increasing the width of the scan pulse of the sub-field having the insufficient discharge pattern, the address discharge can actively occur in a sub-field having a longer address discharge time lag.

In the embodiment of the present invention, the width of the scan pulse applied to all the scan lines of a sub-field in which a discharge cell has the insufficient discharge pattern is increased. However, a width of a scan pulse applied to a scan line in which the discharge cell has the insufficient discharge pattern may be increased and thus the address period may be relatively reduced. Accordingly, efficiency of an address-discharge can be enhanced by identifying insufficient discharge patterns from an input image signal and increasing the width of a scan pulse of a sub-field representing a corresponding gray scale.

While the present invention has been particularly illustrated and described with reference to exemplary embodiments thereof, it will be understood by those of ordinary skill in the art that various changes in form and details may be made therein without departing from the spirit and scope of the present invention as defined by the following claims.

1. A plasma display panel (PDP), comprising:
a panel comprising a plurality of first electrodes and a plurality of second electrodes;
a controller programmed and configured to estimate a gray scale of an input image signal, check an on/off pattern of discharge cells in a sub-field based on the estimated gray scale, and adjust a width of a scan pulse based on the on/off pattern; and
a driver adapted to selectively apply the scan pulse to the plurality of first electrodes based on a signal output from the controller, wherein the controller being further programmed and configured to identify an insufficient discharge cell as being a discharge cell that is selected for discharge in the present sub-field and the discharge cell has not discharged in the previous two sub-fields, the controller also being programmed and configured to increase the width of the scan pulse applied to at least the first electrodes of an identified insufficient discharge cell for the present sub-field.

2. The PDP of claim 1, wherein the controller comprises:
a pattern detector adapted to check a gray scale of the input image signal, consult a memory to check the on/off pattern of the discharge cell prior to the present sub-field, and identify the insufficient discharge cell; and
a data converter adapted to increase the width of the scan pulse applied to the first electrodes during an address period of the present sub-field of an identified insufficient discharge cell based on a signal from the pattern detector and an output signal of an automatic power controller, the data converter further being adapted to output the scan pulse to the driver when the insufficient discharge cell is identified by the pattern detector.

3. The PDP of claim 1, wherein the data converter increases the width of the scan pulse by no more than a length of a pausing period of a frame for the sub-field.

4. The PDP of claim 2, wherein the data converter increases the width of the scan pulse by no more than a length of a pausing period of a frame for the sub-field.

5. The PDP of claim 3, wherein the data converter reduces the pausing period by an amount equal to an amount the width of the scan pulse is increased.

6. The PDP of claim 4, wherein the data converter reduces the pausing period by an amount equal to an amount the width of the scan pulse is increased.

7. The PDP of claim 1, wherein a discharge cell being identified as an insufficient discharge cell for a present sub-field when the discharge cell is being selected for the present sub-field, the present sub-field is the second sub-field in a frame, and the discharge cell was not selected in the first sub-field.

8. A method of driving a plasma display panel (PDP), comprising:
providing the PDP comprising a plurality of first electrodes and a plurality of second electrodes;
estimating a gray scale of an input image signal and checking on/off patterns of discharge cells in a present sub-field representing the gray scale;
identifying an insufficient discharge cell based on the on/off patterns of the discharge cell and based on whether the discharge cell is to be discharged in the present sub-field; and
increasing a width of a scan pulse applied to first electrodes of the insufficient discharge cell during an address period of the present sub-field.

9. The method of claim 8, wherein the insufficient discharge cell being a discharge cell that discharges in a present sub-field and did not discharge in either of two previous sub-fields.

10. The method of claim 8, wherein the insufficient discharge cell being a discharge cell where the present sub-field is a second sub-field of a frame, that discharges in the second sub-field of a frame and did not discharge in the first sub-field of the frame.

11. The method of claim 8, wherein further comprising reducing a width of a pausing period in a frame that comprises the present sub-field by an amount equal to an amount the width of the scan pulse is increased.

12. The method of claim 9, wherein further comprising reducing a width of a pausing period in a frame that comprises the present sub-field by an amount equal to an amount the width of the scan pulse is increased.

13. The method of claim 10, wherein further comprising reducing a width of a pausing period in a frame that comprises the present sub-field by an amount equal to an amount the width of the scan pulse is increased.

14. The method of claim 11, wherein further comprising further modifying a length of the pausing period based on a signal from the automatic power controller based on a brightness of a screen for the PDP.

15. A plasma display panel (PDP), comprising:
a panel comprising a plurality of first electrodes and a plurality of second electrodes;
a controller programmed and configured to modify a driving waveform applied to the first electrodes based on a combination of present and past sub-field data; and
a driver adapted to receive the modified driving waveform signal from the controller and apply the modified driving waveform signal to the first electrodes.

16. The PDP of claim 15, wherein the controller comprises:
an input signal processor adapted to analyze a present sub-field data;
a memory adapted to store past sub-field data;
a pattern detector adapted to receive data from the sub-field data processor and the memory and to identify problem discharge cells; and
a data converter adapted to receive signals from the pattern detector and to modify the present driving waveform signal for discharge cells identified as problem discharge cells.

17. The PDP of claim 16, wherein the present sub-field data being for a particular sub-field within a frame and past sub-field data being signals for previous sub-fields within said frame.

18. The PDP of claim 16, wherein the data converter being further adapted to modify a scan pulse width applied during an address period for the present sub-field based on whether the discharge cell is identified as a problem discharge cell, the data converter not being adapted to modify a driving waveform signal during either of the reset and sustain periods based on whether the discharge cell is labeled as a problem discharge cell.

19. The PDP of claim 16, the controller further comprising an automatic power controller adapted to send signals to the data converter to modify driving waveform signals based on a brightness of a screen of the PDP.

20. The PDP of 18, the data converter being further adapted to shorten a length of a pausing period to compensate for modification to the scan pulse width in the address period.
